(19) United States
(12) Patent Application Publication
(10) Pub. No.: US 2023/0252503 A1
(43) Pub. Date: Aug. 10, 2023

(54) MULTI-STAGE PREDICTION WITH FITTED RESCALING MODEL

(71) Applicant: AMPERITY, INC., Seattle, WA (US)

(72) Inventors: Joyce GORDON, Seattle, WA (US); Pranav Behari LAL, Seattle, WA (US); Nicholas RESNICK, New York, NY (US); James WU, Bellevue, WA (US); Yan YAN, Seattle, WA (US)

(21) Appl. No.: 17/854,154

(22) Filed: Jun. 30, 2022

Related U.S. Application Data
(60) Provisional application No. 63/308,284, filed on Feb. 9, 2022.

(51) Int. Cl. G06Q 30/02; G06N 5/00

(52) U.S. Cl. CPC G06Q 30/0202; G06N 5/003

(57) ABSTRACT

In some aspects, the techniques described herein relate to a method including: receiving a vector, the vector including a plurality of features related to a user; predicting a return probability for the user based on the vector using a first predictive model; adjusting the return probability using a fitted sigmoid function to generate an adjusted return probability; and predicting a lifetime value of the user using the adjusted return probability and at least one other prediction by combining the adjusted return probability and the at least one other prediction.

### CROSS-REFERENCE TO RELATED APPLICATIONS

This application claims the benefit of U.S. Provisional Appl. No. 63/308,284, filed Feb. 9, 2022, and incorporated by reference in its entirety.

### BACKGROUND

Customer lifetime value (CLV) measures the revenue a business receives from a customer over a defined time period. It is a keystone metric in customer-centric marketing because it enables a business to improve the long-term health of its customer relationships. Customer churn models, often included in CLV systems, predict which customers are likely to stop transacting with the business. Understanding churn is a priority for most businesses because acquiring new customers often costs more than retaining existing ones. Thus, businesses use CLV and churn predictions to optimize marketing strategies for customer acquisition and retention, as well as to identify the ideal target audience for these efforts.

### BRIEF SUMMARY

CLV modeling is the linchpin of modern marketing analytics, allowing marketers to build customer relationship management (CRM) strategies based on the predicted value of their customers. The example embodiments provide a CLV prediction system that can be used in multiple deployments and thus is suitable for varying types of input data. The example embodiments utilize encodings and embeddings of raw input data to incorporate signals from high-cardinality data, allowing for the use of such data. The example embodiments also utilize a multi-stage churn-CLV modeling framework that introduces an additional degree of freedom to adjust churn probabilities, which reduces CLV prediction errors while still leveraging a coupled learning pipeline. The example embodiments also utilize a feature-weighted ensemble of generative and discriminative models to adapt to various underlying purchase patterns. These features, alone or combined, consistently outperform benchmarks and improve the prediction of CLV in a turnkey manner.

In some aspects, the techniques described herein relate to a method including receiving a vector, the vector including a plurality of features related to a user; predicting a return probability for the user based on the vector using a first predictive model; adjusting the return probability using a fitted sigmoid function to generate an adjusted return probability; and predicting a lifetime value of the user using the adjusted return probability and at least one other prediction by combining the adjusted return probability and other prediction(s).

In some aspects, the techniques described herein relate to a method wherein the first predictive model includes a classification model configured to generate a probability that a user does not interact with an entity within a forecast window.

In some aspects, the techniques described herein relate to a method wherein adjusting the return probability using a fitted sigmoid function includes inputting the return probability into the fitted sigmoid function.

In some aspects, the techniques described herein relate to a method wherein the fitted sigmoid function includes at least one trainable parameter.

In some aspects, the techniques described herein relate to a method wherein predicting a lifetime value of the user using the adjusted return probability and at least one other prediction includes computing a product of the adjusted return probability and other predictions.

In some aspects, the techniques described herein relate to a method wherein predicting a lifetime value of the user using the adjusted return probability and at least one other prediction includes predicting an average order value of the user using the vector and an order frequency of the user using the vector and combining the average order value, order frequency, and adjusted return probability.

In some aspects, the techniques described herein relate to a method including training a first predictive model using a training dataset, the first predictive model configured to output a probabilistic value; training a plurality of discriminative models using the training dataset, each of the plurality of discriminative models configured to output a continuous value; generating a fitted sigmoid function by fitting at least one parameter of a; and generating a CLV model using the fitted sigmoid function, the first predictive model, and the plurality of discriminative models.

In some aspects, the techniques described herein relate to a method wherein the plurality of discriminative models includes a plurality of random forest models.

In some aspects, the techniques described herein relate to a method wherein the plurality of random forest models include an order frequency random forest model and an average order value (AOV) random forest model.

In some aspects, the techniques described herein relate to a method wherein the first predictive model includes a random forest model predicting a churn probability of a user.

In some aspects, the techniques described herein relate to a method wherein generating the fitted sigmoid function includes computing an error metric (e.g., a summation of differences) between predicted CLVs and a ground truth CLVs for a plurality of users in the training dataset and identifying a value of the at least one parameter that minimizes the summation.

In some aspects, the techniques described herein relate to a method wherein computing an error metric between predicted CLVs and a ground truth CLVs includes computing an arg min of the summation.

In some aspects, the techniques described herein relate to a method wherein generating the CLV model using the fitted sigmoid function, the first predictive model, and the plurality of discriminative models includes multiplying the predictions of the first predictive model and the plurality of discriminative models by the output of the sigmoid function.

In some aspects, the techniques described herein relate to a non-transitory computer-readable storage medium for tangibly storing computer program instructions capable of being executed by a computer processor, the computer program instructions defining steps of training a first predictive model using a training dataset, the first predictive model configured to output a probabilistic value; training a plurality of discriminative models using the training dataset, each of the plurality of discriminative models configured to output a continuous value; generating a fitted sigmoid function by fitting at least one parameter of a sigmoid function, the at least one parameter identified by finding a corresponding minimum value that satisfies a predefined cost function; and generating a customer lifetime value (CLV) model using the fitted sigmoid function, the first predictive model, and the plurality of discriminative models.

In some aspects, the techniques described herein relate to a non-transitory computer-readable storage medium, wherein the plurality of discriminative models includes a plurality of random forest models.

In some aspects, the techniques described herein relate to a non-transitory computer-readable storage medium, wherein the plurality of random forest models include an order frequency random forest model and an average order value (AOV) random forest model.

In some aspects, the techniques described herein relate to a non-transitory computer-readable storage medium, wherein the first predictive model includes a random forest model predicting a churn probability of a user.

In some aspects, the techniques described herein relate to a non-transitory computer-readable storage medium, wherein generating the fitted sigmoid function includes computing an error metric (e.g., summation of differences) between predicted CLVs and a ground truth CLVs for a plurality of users in the training dataset and identifying a value of at least one parameter that minimizes the summation.

In some aspects, the techniques described herein relate to a non-transitory computer-readable storage medium, wherein computing an error metric between predicted CLVs and a ground truth CLVs includes computing an arg min of the summation.

In some aspects, the techniques described herein relate to a non-transitory computer-readable storage medium, wherein generating the CLV model using the fitted sigmoid function, the first predictive model, and the plurality of discriminative models includes multiplying the predictions of the first predictive model and the plurality of discriminative models by the output of the sigmoid function.

### BRIEF DESCRIPTION OF THE DRAWINGS

FIG. 1 is a block diagram of a system for predicting a CLV according to some of the example embodiments.

FIG. 2 is a block diagram of a multi-stage model for predicting a CLV according to some of the example embodiments.

FIG. 3 is a flow diagram illustrating a method for training a multi-stage model according to some of the example embodiments.

FIG. 4 is a flow diagram illustrating a method for predicting a CLV using a multi-stage model according to some of the example embodiments.

FIG. 5 is a block diagram of a computing device according to some embodiments of the disclosure.

FIG. 6 is a graph illustrating the performance of parameters of a fitted sigmoid function in differing scenarios.

FIG. 7 is a graph of an ablation study performed with respect to various permutations of Bayesian encodings, embeddings, and transactional features.

### DETAILED DESCRIPTION

The example embodiments describe a multi-stage ML model for predicting the customer lifetime value (CLV) (over a fixed time horizon) of a given user data object. In the various embodiments, the CLV of a given user data object x is represented as

$$\begin{matrix}C L V ( x ) = {σ}_{{t}_{1}^{*} {t}_{2}^{*}} ( {P}_{return} ( x ) ) C L {V}_{return} ( x ) \\ = {σ}_{{t}_{1}^{*} {t}_{2}^{*}} ( {P}_{return} ( x ) ) {AOV}_{r e C u r n} ( x ) F r e {q}_{r e C u r n} ( x ) \\ = {σ}_{{c}_{1}^{*} {c}_{2}^{*}} ( 1 - {P}_{c h u r n} ( x ) ) A 0 {V}_{r e C u r n} ( x ) F r e {q}_{r e C u r n} ( x )\end{matrix} \qquad Equation 1$$

In Equation 1, Pᵣₑₜᵤᵣₙ represents a model of the probability of a user x interacting with an entity (e.g., merchant) over a fixed time horizon (e.g., purchasing an item from a store or online). In an embodiment, this probability can be alternatively represented as 1−P_{churn}(x), where P_{churn} represents a model of the probability that a given user does not interact with an entity over the fixed time horizon. Further, CLVᵣₑₜᵤᵣₙ represents a model of the lifetime value of a returning user over the fixed time horizon without considering the churn probability of the user. The model CLVᵣₑₜᵤᵣₙ is represented as the product of two separate models: AOVᵣₑₜᵤᵣₙ which is a model of the average order value of a returning user and Freqᵣₑₜᵤᵣₙ which is a model of the frequency in which a returning user interacts with an entity. As illustrated in Equation 1, the model CLVᵣₑₜᵤᵣₙ can be represented as the product of AOVᵣₑₜᵤᵣₙ and Freqᵣₑₜᵤᵣₙ.

Equation 1 further illustrates the use of a trained sigmoid operation (σₜ_{₁}_{*t}_{₂}_{*}(x)) which adjusts or distorts the output of the model Pᵣₑₜᵤᵣₙ. In an embodiment, the trained sigmoid operation is trained by using the total CLV prediction error as a cost function to select optimal values of t₁ and t₂ of the sigmoid operation. In an embodiment, the sigmoid operation can comprise a two-parameter sigmoid function, such as:

$$σ ( x ) = \frac{1}{1 + {e}^{- {t}_{1} * ( x - {t}_{2} )}} \qquad Equation 2$$

However, other sigmoid functions may be used. Indeed, any sigmoid with one or more adjustable parameters may be used.

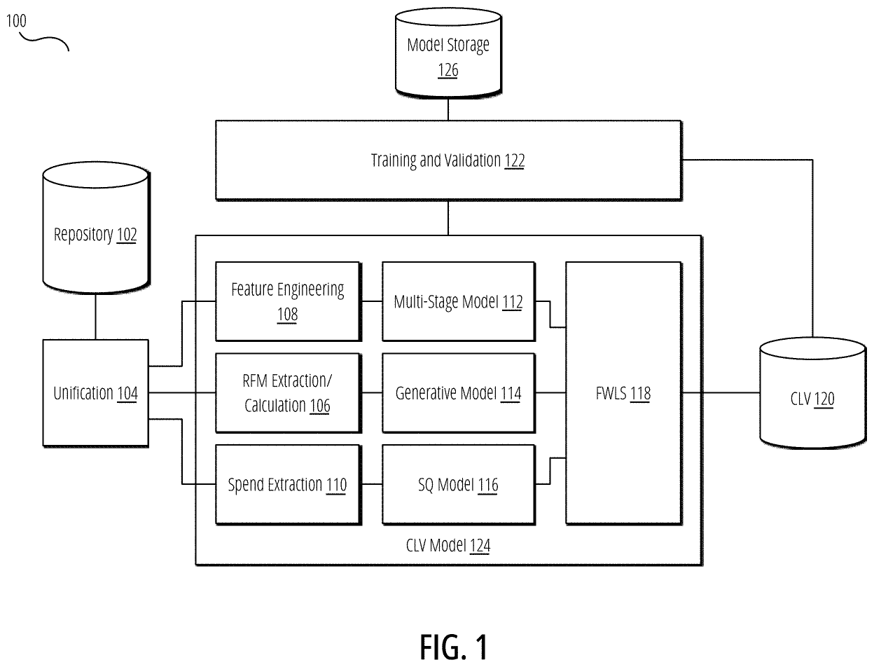

FIG. 1 is a block diagram of a system for predicting a CLV according to some of the example embodiments.

System 100 includes a repository 102 of data. Repository 102 may comprise a raw data storage device or set of devices (e.g., distributed database). The specific storage technologies used to implement repository 102 are not limiting. As one example, the repository 102 can store data related to customer commerce data for a merchant, such as user contact details (e.g., a unique identifier, city, state, zip or post code, birthday, first name, last name, email domain or full email, gender, phone, identifier of a store nearest the user, identifier of a store preferred by the user, a Boolean flag indicating whether the user is employed by the retailer, and a Boolean flag indicating whether the user is a reseller). As used herein, a “merchant” refers to any organization or individual using system 100, while a user or customer refers to a customer of the merchant of which data is collected by the merchant, system 100, or other third-party system. The repository 102 can also include online sales data, that is, data fields relating to online transactions associated with the user and the merchant. The repository 102 can also include offline sales data (e.g., point-of-sale or brick-and-mortar transactions) between users and the merchant. Sales data can include fields such as an order identifier, order date, total order value, order quantity, order discount amount, returned item value, canceled order value, order channel identifier, store identifier, currency, etc. The sales data can also include individual product details for each product in an order, such as a product identifier, product name, product quantity, product family, color category, etc. Such data can be cross-referenced with a product catalog of the merchant stored in repository 102 and/or merchant-specific data stored in repository 102. Other types of data such as email engagement data (e.g., receiver email address, email type, send date, opened flag, opened date, clicked flag, clicked data, etc.) or event participation data (e.g., event identifier, event type, event zip or post code, flag indicating whether the user is a volunteer, flag indicating whether a user completed a purchase at or after the event, etc.).

A unification pipeline 104 is communicatively coupled to repository 102 and reads data from repository 102 during a preconfigured time window (e.g., every month). The data stored in repository 102 may not be unified in advance. That is, individual records in repository 102 may not be associated with a single user. Thus, unification pipeline 104 reads all data from the repository 102 during a given time window and unifies the data on a per-user basis to generate unified datasets for each unique user in the data stored in repository 102. As one example, the same real-world user may complete an online transaction as well as a physical transaction. In some scenarios, these two records may not be linked in repository 102 for a variety of reasons. For example, when users make in-store purchases, most purchases are not linked to online accounts due to the difficulties in harmonizing the real and digital worlds. Further, names and other details used in online versus real-world scenarios may differ. Thus, a user's online account may use the name “Jane Doe” while a real-world transaction may only use the user's initial and last name (“J. Doe”) or may not use the user's name at all. In essence, the unification pipeline 104 acts as a clustering routine for clustering records into per-user clusters. Specifically, details of unification pipeline 104 are not limiting and are further described in commonly-owned U.S. Pat. No. 11,003,643 and commonly-owned applications bearing U.S. Ser. Nos. 16/938,233 and 16/938,591, the details of which are incorporated by reference in their entirety.

System 100 includes a CLV model 124 that includes a plurality of sub-models combined via feature-weighted linear stacking (FWLS). Specifically, the CLV model 124 includes a multi-stage model 112, a generative model 114, and a status quo, SQ model 116. The outputs of each model are input to an FWLS model 118, which combines the predictions to form a CLV prediction written to CLV storage 120.

In an embodiment, the SQ model 116 comprises a model that assumes the behavior of each user over the next time window is the same as their behavior in the previous window. That is, the SQ model 116 predicts that the CLV for a given time window (e.g., next year) is equal to the total spend during the previous time window (e.g., last year). While the SQ model 116 is generally simplistic and deterministic, it captures the distribution of order values and provides a stable baseline when no better information is available. In some embodiments, the SQ model 116 does not require any training as the model predicts CLV based only on historical data and arithmetic computations. For example, during prediction, a spend extraction component 110 can, for a given user, load all transactions over the last time window (e.g., last year) and input all transactions into the SQ model 116. The SQ model 116 can first determine if the number of transactions is greater than zero. If not, the SQ model 116 can output zero as its prediction. Alternatively, when a user has a transaction in the last time window, the SQ model 116 predicts a future transaction. To predict the CLV for the next time window, SQ model 116 can compute the average per-unit (e.g., per-week) transaction amount during the last time window and multiply that average by the total number of units in the future time window (e.g., 52 weeks for a one-year time window).

The CLV model 124 also includes a generative model 114. The generative model 114 may comprise, for example, an extended Pareto/negative binomial distribution (EP/NBD) model or a similar model (e.g., EP/NBD with gamma-gamma extension). In an embodiment, the generative model 114 receives processed data from recency, frequency, and monetary (RFM) data generated by an RFM component 106. In such an embodiment, RFM component 106 can generate RFM data for each user.

In an embodiment, recency data for a user can comprise the time between the first and the last interaction recorded. In an embodiment, frequency data can include a number of interactions beyond an initial interaction. In an embodiment, monetary data can comprise an arithmetic mean of a user's interaction value (e.g., price). In some embodiments, each of the RFM values can be calculated for a preset period (e.g., the last year). In some embodiments, the RFM values can include additional features such as a time value which represents the time between the first interaction and the end of a preset period.

In the illustrated embodiment, a generative model 114 ingests the data (e.g., RFM data) from RFM component 106 and fits a generative model. In an embodiment, the generative model can include any statistical model of a joint probability distribution reflecting a lifetime value of a user for a given forecasting period as discussed above such as an EP/NBD model. In some embodiments, the Pareto/NBD model can further include a gamma-gamma model or other extension. Other models, such as a beta geometric (BG)/NBD, can also be used. In some embodiments, existing libraries can be used to fit a generative model using the data (e.g., RFM data), and the details of fitting a generative model are not recited in detail herein.

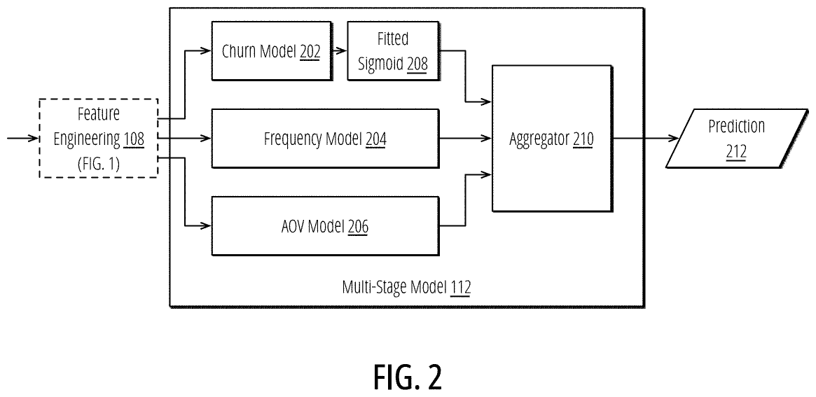

The CLV model 124 also includes a multi-stage model 112, which receives feature vectors from a feature engineering stage 108 and generates a CLV output to input into FWLS model 118. In an embodiment, the multi-stage model 112 includes a multi-stage random forest (RF) model and an additional churn probability adjustment function for CLV error reduction. Other types of discriminative models may be used along with the churn probability adjustment. Details of multi-stage model 112 are provided next in FIG. 2 and not repeated herein for the sake of clarity.

As illustrated, unified data from unification pipeline 104 is feature engineered by feature engineering stage 108 to obtain feature vectors representing a given user. In some instances, numerical data associated with a given user (e.g., age, order date, etc.) may be used as features in the feature. However, feature engineering stage 108 can transform categorical features (e.g., gender, city, state, product name, etc.) into numerical features to improve training and prediction of multi-stage model 112. Various techniques to generate a feature vector for a given user are described below.

In some embodiments, the feature vector can include a plurality of transactional features. In an embodiment, a transactional feature can be generated by analyzing data associated with a given user and, if necessary, performing one or more arithmetic operations on the data to obtain a transactional feature. For example, transactional features can include a lifetime order frequency of a user, a lifetime order recency of a user, the number of days since the user's last order, the number of days since the user's first order, a lifetime order total amount, a lifetime largest order value, a lifetime order density, a percentage of the number of total distinct order months, an average order discount percentage, an average order quantity, a total number of holiday orders, a total holiday order amount, a total holiday order discount amount, number of returned items, total value of returned items, and a Boolean flag as to whether the user is a multi-channel customer. Some of all of the foregoing features can also be computed over time periods less than the lifetime of the user. For example, the same or similar features can be calculated over the last 30, 60, 90, or 180 days (as examples). Similarly, the same or similar metrics can be computed for the first and last order of a user. Finally, the features can include product or item-level data (e.g., for the first, last, and most common items). Table 1 illustrates one example of a feature vector using the foregoing transactional features and is not limiting,

TABLE 1

| No. | Category | Feature Name | Vector Location |
|---|---|---|---|
| 1 | Lifetime | lifetime order frequency | x[0] . . . x[14] |
| 2 | | lifetime order recency | |
| 3 | | days since latest order | |
| 4 | | days since first order | |
| 5 | | order total amount | |
| 6 | | lifetime largest order value | |
| 7 | | lifetime order density | |
| 8 | | percentage distinct order months | |
| 9 | | average order discount amount | |
| 10 | | average order discount percentage | |
| 11 | | average order quantity | |
| 12 | | num holiday orders | |
| 13 | | total holiday order amount | |
| 14 | | total holiday order discount | |
| | | amount | |
| 15 | | is multi channel | |
| 16 | Periodic (e.g., last | order total amount | x[15] . . . x[43] |
| 17 | 30, 90, 180, 365 | average order value | |
| 18 | days) | order frequency | |
| 19 | | order frequency on discount | |
| 20 | | total discount amount | |
| 21 | | num items returned | |
| 22 | | total returned amount | |
| 23 | Single Order (e.g., | order amount (first and last) | x[44] . . . x[58] |
| 24 | first and last) | order discount amount | |
| 25 | | order week | |
| 26 | | order month | |
| 27 | | order store id | |
| 28 | | order channel | |
| 29 | | order brand | |
| 30 | Item-Level (e.g., for | item category | x[59] . . . x[71] |
| 31 | first, last, and most | item subcategory | |
| 32 | commonly purchased | item department | |
| 33 | items) | item size | |
| 34 | Seasonality | current year | x[72] |
| 35 | | current month | x[73] |

In Table 1, the fifteen lifetime features correspond to the first fifteen features of vector x (x[0] through x[14]). As illustrated, the seven periodic features (e.g., 15 through 22) are repeated four times (for the last 30, 90, 180, and 365 windows) to create 28 features in x (x[15] through x[43]). The seven single order features are calculated twice (for the first and last orders of the user) to create 14 features in x (x[44] through x[58]) and the four item-level features are performed three times (for first, last, and most purchased item) to obtain twelve features (x[59] through x[71]). Finally, the vector x includes two features for the current year (x[72]) and current month (x[73]). The foregoing table, and features x[0] . . . x[73] are exemplary only and fewer or more features can be added. For example, the periodic, single order, and item-level features can be increased or decreased as desired.

In addition to transactional features described above, the feature engineering stage 108 can also generate a plurality of Bayesian encodings. In an embodiment, the feature engineering stage 108 can select categorical features of a user and generate numerical representations based on their correlation to the target variable of these features to aid in classification.

In an embodiment, the feature engineering stage 108 can use a statistical method such as empirical Bayes (EB) to generate these encodings. The feature engineering stage 108 can estimate the conditional expectation of the target variable (θ) given a specific feature value (Xᵢ) of a high-cardinality feature (X):

$${f}_{E B} ( {X}_{i} ) = E ( θ \vert X = {X}_{i} ) = \frac{{\sum }_{k ∈ {L}_{i}} {θ}_{k}}{{n}_{i}} \qquad Equation 3$$

In Equation 3, Lᵢ represents the set of observations with the value Xᵢ and nᵢ is the sample size. The feature engineering stage 108 may use Equation 1 to build Bayesian encodings for each categorical value associated with a user. For binary (e.g., Boolean) features, the structure of Equation 1 remains nearly unchanged, except the expected value becomes the estimated probabilities, i.e., Σ_{k∈L}_{ᵢ} θₖ becomes the count of positive observations. In some embodiments, a weighting factor represented as a function of the sample size should be used to blend E(X=Xᵢ) with the sample expectation θ, i.e.:

f_{EB}(Xᵢ)=λ(nᵢ)E(θ|X=Xᵢ)+(1−λ(nᵢ))θ̅. Equation 4

In some embodiments:

$$λ ( {n}_{i} ) = {n}_{i} / ( \frac{{σ}_{i}^{2}}{{σ}^{2} + {n}_{i}} ) \qquad Equation 5$$

In Equation 5, σᵢ² is the variance given X=Xᵢ and σ² is the variance of the entire sample. Noisier (higher variance) data in the sample compared to the overall dataset results in smaller λ(nᵢ) and more shrinkage toward the population mean.

The following simplified example illustrates the calculation and application of two EB features (order frequency and CLV for a categorical feature of an email domain and a categorical feature of a zip code). Table 2 illustrates a training data set:

TABLE 3

| ID | Domain | Zip | Order Frequency | CLV |
|---|---|---|---|---|
| abc_123 | gmail.com | 10012 | 2 | 250 |
| def_234 | aol.com | 98101 | 4 | 100 |
| ghi_567 | aol.com | 10012 | 1 | 150 |
| jkl_890 | gmail.com | 98101 | 10 | 500 |

In Table 3, the domain and zip fields are both categorical (e.g., non-numeric, high cardinality) fields. In the following Table 4 and Table 5, two tables illustrating the generation of four EB encodings are illustrated:

TABLE 4

| Domain | E (freq\|domain) | E (CLV\|domain) |
|---|---|---|
| gmail.com | 6 | 375 |
| aol.com | 2.5 | 125 |

TABLE 5

| Zip | E (freq\|zip) | E (CLV\|zip) |
|---|---|---|
| 10012 | 1.5 | 200 |
| 98101 | 7 | 300 |

In Table 4, the value of E(freq|domain) represents the average order frequency for all records having a given email domain. For example, the average order frequency is computed across users abc_123 and jkl_890. A similar calculation is performed with respect to the corresponding CLV values. Similarly, in Table 5, the order frequency and CLV for all users having a given zip code are aggregated (e.g., averaged). The corresponding Bayesian encodings thus represent the likely (e.g., average) order frequencies for all users having a given email domain or zip code and the likely (e.g., average) CLV for all users having a given email domain or zip code. These encodings can be joined to the original data from Table 3 for ease of extraction by feature engineering stage 108, as illustrated in Table 6:

TABLE 6

| ID | Domain | Zip | Freq. | CLV | E(f\|d) | E(CLV\|d) | E(f\|z) | E(CLV\|z) |
|---|---|---|---|---|---|---|---|---|
| abc_123 | gmail.com | 10012 | 2 | 250 | 6 | 375 | 1.5 | 200 |
| def_234 | aol.com | 98101 | 4 | 100 | 2.5 | 125 | 7 | 300 |
| ghi_567 | aol.com | 10012 | 1 | 150 | 2.5 | 125 | 1.5 | 200 |
| jkl_890 | gmail.com | 98101 | 10 | 500 | 6 | 375 | 7 | 300 |

In Table 6, E(f|d) and E(CLV|d) corresponds to the average frequency and average CLV for a given email domain (computed in Table 4) and E(f|z) and E(CLV|z) correspond to the average frequency and average CLV for a given zip code (computed in Table 5).

The use of EB encoding allows the system 100 to encode any high-cardinality categorical feature as a continuous scalar feature. As such, it provides technical benefits in the form of handling low frequency values and missing values very well; the features are simple to interpret, inspect, and monitor; the predictive relevance of new fields can be automatically captured without the need for bespoke feature engineering; the implementation can be as simple as database queries; the computation is fast and parallelizable, making it well-suited for large-scale environments.

In addition to transactional and Bayesian encoding features described above, the feature engineering stage 108 can also generate embedding representations of some of all features associated with a given user. In some embodiments, the feature engineering stage 108 can use a word2vec algorithm or similar embedding algorithm to generate such embeddings.

While the EB encodings relate purchase propensities to high-cardinality categorical attributes, some encodings may not necessarily capture more complex purchasing patterns in the data. By contrast, neural embeddings are a popular way of generating dense numerical features from such patterns. This is especially true of large datasets, such as itemized browsing data, which usually contain rich and ever-changing product-level information. In some embodiments, the feature engineering stage 108 can use product-level purchase data to generate embeddings. Itemized transaction data can be grouped at the product level, and customers that purchased that product can then be sorted in ascending order by purchase time. In the context of word2vec's typical application in natural language processing, the feature engineering stage 108 can treat products as documents and customers (e.g., represented by ID strings) as words. Analogous to the word2vec assumption that similar words tend to appear in the same observation windows, customers who purchase a given product around the same time tend to be similar. Thus, when applied to such data, the output of word2vec is a customer-level embedding, which the system 100 can use directly as features in the multi-stage model 112.

After training a Word2Vec model, feature engineering stage 108 uses data up T−Δt, that is, the last Δt-length window preceding the current time T. To update embeddings at inference time (i.e., T), the feature engineering stage 108 can calculate product-level embeddings by taking the mean across the embeddings of customers that have purchased that product. Then, for customers that exist during training time, the feature engineering stage 108 can take the mean of their original embedding and the embeddings of any new products they purchased since training. For new customers, the feature engineering stage 108 can instead set their embedding as the mean of the product-level embeddings they have purchased.

In addition to transactional, Bayesian encoding, and embedding features described above, the feature engineering stage 108 can also generate custom or handcrafted features on a per-merchant basis. Such features can include, as examples, the clumpiness of a user, holiday purchases, discount tendency, return tendency, cancellation tendency, multi-channel shopping, email engagement, etc. As used herein, dumpiness refers to a metric to quantify irregularity in a customer's intertemporal purchase patterns, defined as the ratio between the days across the first and last purchases and the days since the first purchase. Holiday purchases refers to how much a customer shops during holidays compared to non-holidays. The discount, return, and cancellation tendencies refer to features related to discount, returned, and canceled purchases. The multi-channel shopping feature refers to how much a customer's purchase is spread across different purchase channels. Email engagement refers to the number of email opens and clicks, as well as the recency of their last email engagements. Other types of features such as the number of events a user attends or the number of events a user volunteers at may also be considered.

The foregoing Bayesian encodings, embeddings, and handcrafted features can be added to the feature vector x first described in Table 1 to form a complete feature vector. One non-limiting example of such a feature vector is fully depicted in Table 7 below:

TABLE 7

| No. | Category | Feature Name | Vector Location |
|---|---|---|---|
| 1 | Lifetime | lifetime order frequency | x[0] . . . x[14] |
| 2 | | lifetime order recency | |
| 3 | | days since latest order | |
| 4 | | days since first order | |
| 5 | | order total amount | |
| 6 | | lifetime largest order value | |
| 7 | | lifetime order density | |
| 8 | | percentage distinct order months | |
| 9 | | average order discount amount | |
| 10 | | average order discount percentage | |
| 11 | | average order quantity | |
| 12 | | num holiday orders | |
| 13 | | total holiday order amount | |
| 14 | | total holiday order discount amount | |
| 15 | | is multi channel | |
| 16 | Periodic (e.g., | order total amount | x[15] . . . x[43] |
| 17 | last 30, 90, 180, | average order value | |
| 18 | 365 days) | order frequency | |
| 19 | | order frequency on discount | |
| 20 | | total discount amount | |
| 21 | | num items returned | |
| 22 | | total returned amount | |
| 23 | Single Order | order amount (first and last) | x[44] . . . x[58] |
| 24 | (e.g., first and | order discount amount | |
| 25 | last) | order week | |
| 26 | | order month | |
| 27 | | order store id | |
| 28 | | order channel | |
| 29 | | order brand | |
| 30 | Item-Level (e.g., | item category | x[59] . . . x[71] |
| 31 | for first, last, | item subcategory | |
| 32 | and most commonly | item department | |
| 33 | purchased items) | item size | |
| 34 | Seasonality | current year | x[72] |
| 35 | | current month | x[73] |
| 36 | word2vec | word2vec embeddings | x[74] . . . x[116] |
| 37 | EB Encodings | average spend over 90 days w/r/t SKU | x[117] . . . x[178] |
| 38 | | average spend over 365 days w/r/t SKU | |
| 39 | | . . . | |
| 40 | | average freq. over 90 days w/r/t SKU | |
| 41 | | average freq. over 365 days w/r/t SKU | |
| 42 | | average lifetime spend w/r/t surname | |
| 43 | | average lifetime spend w/r/t zip | |
| 44 | | . . . | |
| 45 | | average frequency w/r/t surname | |
| 46 | | average frequency w/r/t zip | |
| 47 | Custom | number of email clicks | x[178] . . . x[192] |
| 48 | | number of email opens | |
| 49 | | . . . | |
| 50 | | number of events | |
| 51 | | number of volunteer events | |

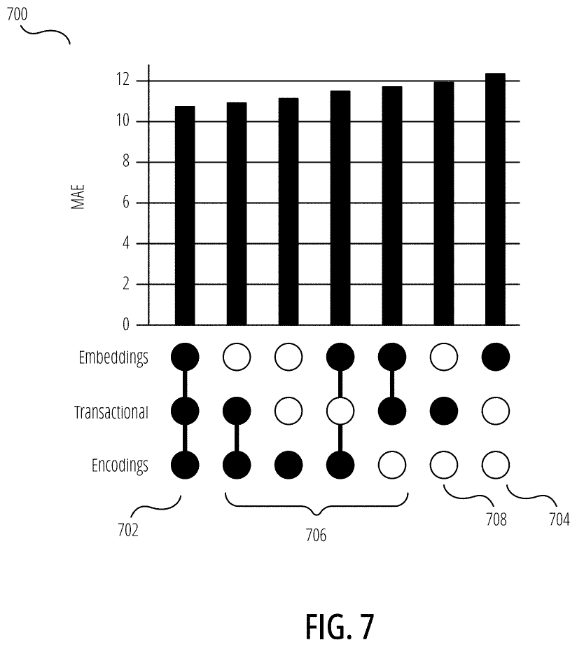

Some of all of the Bayesian encodings, embeddings, and transactional features can be used and each provides varying improvements in the mean absolute error (MAE) of the multi-stage model 112. FIG. 7 is a graph 700 of an ablation study performed with respect to various permutations of Bayesian encodings, embeddings, and transactional features. As illustrated, the use of Bayesian encodings, embeddings, and transactional features (combination 702) represents the lowest MAE obtained during training while using only embeddings (combination 704) represents the highest MAE. Various other combinations 706 and transaction-only combination 708 generally result in MAE values between these two extremes. As illustrated in FIG. 7, the addition of both Bayesian encodings and embeddings to transactional features (represented as combination 702) represents an approximately 7.42% improvement in MAE during training as compared to the use of only transactional features (transaction-only combination 708).

The foregoing feature vectors are used to train the multi-stage model 112 as well as predict using the multi-stage model 112, discussed more fully in connection with FIG. 2. Additionally, further detail on generate feature vectors is provided in commonly-owned application bearing U.S. Ser. No. 16/938,591, which is incorporated herein in its entirety.

FIG. 2 is a block diagram of a multi-stage model for predicting a CLV according to some of the example embodiments.

In the illustrated embodiment, the multi-stage model 112 includes a churn model 202, frequency model 204, and average order value model (AOV model 206). In some embodiments, the churn model 202, frequency model 204, and AOV model 206 may comprise a multi-stage random forest model, the churn model 202, frequency model 204, and AOV model 206 comprising sub-models thereof.

The outputs of the frequency model 204 and AOV model 206 are fed to an aggregator 210, while the output of the churn model 202 is processed by a fitted sigmoid 208 and the output of the fitted sigmoid 208 is input to the aggregator 210. The aggregator 210 combines the output of fitted sigmoid 208, frequency model 204 and AOV model 206 and outputs a final prediction 212 that blends each output.

In an embodiment, the churn model 202 can comprise a binary classifier that is trained to predict (from a feature vector generated by feature engineering stage 108) the probability a user will churn (i.e., not make a purchase) during a forecasted time window. The output of the churn model 202 as P_{churn}(x), the probability that the user x will churn or, when convenient, the complement of P_{churn}(x), namely, Pᵣₑₜᵤᵣₙ(x)=1−P_{churn}(x), where Pᵣₑₜᵤᵣₙ(x) represents the likelihood that a user x will return to a merchant and make a purchase.

As illustrated, the output of the churn model 202 is transformed via fitted sigmoid 208. In an embodiment, the fitted sigmoid 208 can comprise a two-parameter sigmoid function, such as:

$$σ ( x ) = \frac{1}{1 + {e}^{- {t}_{1} * ( x - {t}_{2} )}} \qquad Equation 6$$

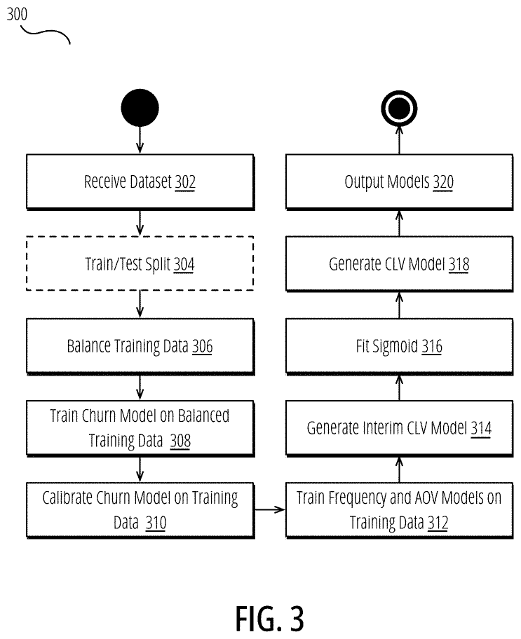

However, other sigmoid functions may be used. Indeed, any sigmoid with one or more adjustable parameters may be used. As will be discussed in more detail in FIG. 3, the fitted sigmoid 208 comprises a trained function that minimizes the error impact of incorporating churn prediction into CLV prediction. Specifically, the AOV model 206 and the frequency model 204 may both comprise regression models (e.g., linear regression models) that predict a user's average order value and frequency of orders over a forecasted time window. As used herein, the output of frequency model 204 may be represented as Freqᵣₑₜᵤᵣₙ(x) while the output of AOV model 206 may be represented as AOVᵣₑₜᵤᵣₙ(x) which comprise the frequency of orders and average value of orders for a user x in a forecast window. In existing systems, CLV generally can be represented as a product of the AOV model 206 and frequency model 204 (e.g., CLVᵣₑₜᵤᵣₙ(x)=Freqᵣₑₜᵤᵣₙ(x) AOVᵣₑₜᵤᵣₙ(x). For example, a frequency of ten orders and average order value of five dollars over a forecast window would result in a CLV of fifty dollars. Indeed, aggregator 210 may perform this interim calculation using the outputs of frequency model 204 and AOV model 206. However, the aggregator 210 also adjusts the value of CLVᵣₑₜᵤᵣₙ(x) by both the predicted churn probability Pᵣₑₜᵤᵣₙ(x) and the fitted sigmoid function σₜ_{₁}_{*t}_{₂}_{*} Thus, the aggregator 210 may compute the CLV of a given user x as the product

CLV(x)=σₜ_{₁}_{*t}_{₂}_{*}(Pᵣₑₜᵤᵣₙ(x))CLVᵣₑₜᵤᵣₙ(x) Equation 7

Notably, existing systems may use churn probabilities and traditional CLV predictions as the predictions are related. However, most systems treat churn predictions as Boolean inputs. Such an approach yields multiple deficiencies in the current art.

For non-contractual businesses, the two classes, return versus churned, are often very imbalanced. When learning from highly imbalanced data, most classifiers are overwhelmed by the majority class examples, so false-negative rates tend to be high. Under-sampling the majority class or resampling the minority class can alleviate this issue, but it also modifies the priors of the training set, which biases the posterior probabilities of a classifier. Further, most classifiers assume that misclassification costs (false negative and false positive costs) are the same. In real-world applications, this assumption is rarely true. For example, the cost of additional engagement with a return customer predicted to churn is far less than the cost of potentially losing a loyal customer. Finally, the misclassification costs involved in churn and CLV models are different. A churn model, even well-calibrated to address the class imbalance, does not necessarily minimize the CLV prediction error because different types of churn misclassifications have different levels of impact on CLV errors. Empirically, this problem is more prominent in merchants with high AOVs and high churn rates.

It should be noted that the models used for churn model 202, frequency model 204, and AOV model 206 can vary depending on the needs of multi-stage model 112, and specific model topologies or types are not necessarily limiting, provided their outputs comprise a probability (for churn model 202), average order value (for AOV model 206), and order frequency (for frequency model 204).

Returning to FIG. 1, the outputs of multi-stage model 112, generative model 114, and SQ model 116 are input into FWLS model 118. The FWLS model 118 comprises a feature-weighted linear stacking ensemble used to generate final CLV predictions, which are stored in CLV storage 120 based on the individual predictions of multi-stage model 112, generative model 114, and SQ model 116.

One key challenge with using discriminative models for CLV modeling is that data from the most recent year (or similar holdout period) must be used to compute the target variable for training (the observed CLV), while generative models do not require holding out data. The impact of this loss in signal in discriminative techniques can be exacerbated by relatively short-term fluctuations in user behavior (such as the COVID-19 pandemic). The use of FWLS model 118 alleviates this sensitivity by blending the outputs of multi-stage model 112, generative model 114, and SQ model 116, combining the benefits of both discriminative (e.g., multi-stage model 112) and generative approaches (e.g., generative model 114). Details of FWLS model 118 are provided in commonly-owned U.S. application Ser. No. 17/511,747 and are not repeated herein.

As opposed to standard linear stacking, where base models are blended with constant weights, FWLS assumes the predictive power of each base model varies as a linear function of individual-level information (i.e., meta-features). For instance, EP/NBD may be more reliable than an RF model for customers with a long and consistent transaction history with the brand. FWLS inherits many benefits of linear models, such as low computation costs, minimal tuning, and interpretability, while still providing a significant boost on predictive performance.

In some embodiments, FWLS model 118 may be represented as:

$$C L {V}_{F W L S} ( x ) = {\sum }_{k = 1}^{K} {\sum }_{m = 1}^{M} {v}_{m , k} {f}_{m} ( x ) C L {V}_{k} ( x ) \qquad Equation 8$$

In Equation 8, fₘ comprises meta-features of the FWLS model and CLVₖ(x) comprise the base model predictions (e.g., of multi-stage model 112, generative model 114, and SQ model 116). The blending weights are linear functions of meta-features (e.g., Σₘ₌₁^{M}v_{m,k}fₘ(x). Thus, solving the FWLS optimization problem becomes fitting a linear regression model with K×M features. While more meta-features may improve predictive performance, in some embodiments, the FWLS model 118 maintains a small set of meta-features when implementing FWLS due to the computation cost of training growing quadratically with the number of meta-features.

In an embodiment, a training and validation stage 122 can continuously train and validate each multi-stage model 112, generative model 114, SQ model 116, and FWLS model 118 and store the models in model storage 126. In some embodiments, model storage 126 can store all weights, hyperparameters, or other defining characteristics of each model.

As an example, each of the models can be retrained weekly to incorporate new signals with reasonable computational cost. Then, predictions can be generated and stored in CLV storage 120 and served daily. In some embodiments, system 100 can monitor both weekly retraining and daily predictions to ensure the reliability of predictions delivered to brands.

In some embodiments, the system 100 can monitor two types of data drift. First, the system 100 can measure weekly model stability. In some embodiments, the stability of a model can be represented as the difference in predictions by app lying different model versions j and j+1:

Δ(Pred(Dᵢ,Mⱼ),Pred(Dᵢ,Mⱼ₊₁) Equation 9

In Equation 9, Pred comprises predictions of a model M and Dᵢ represents a dataset of users. A second type of drift may comprise a daily prediction jitter represented as:

Δ(Pred(Dᵢ,Mⱼ),Pred(Dᵢ₊₁,Mⱼ) Equation 10

In Equation 10, Dᵢ₊₁ represents a later dataset re-run (i.e., fed) using the same model as a past dataset (Dᵢ). In both Equation 9 and Equation 10, the function Δ(⋅) may comprise a Kullback-Leibler Divergence and difference in means. In some embodiments, when training and validation stage 122 detects excessive drift in either equation, alerts are triggered for operator investigation and intervention for a given model; otherwise, the model is deployed, and predictions are served.

FIG. 3 is a flow diagram illustrating a method for training a multi-stage model according to some of the example embodiments.

In step 302, method 300 can include receiving a dataset (D). In some embodiments, the dataset can include a plurality of examples or feature vectors, each feature vector including a plurality of features. Details of feature vectors are provided in the previous descriptions and are not repeated herein. In step 302, each feature vector can be associated with one or more ground truth values or labels. In an embodiment, the ground truth labels can be obtained by holding out a most recent subset of the dataset. For example, if the forecast window targeted by the multi-stage model is one year, the holdout period can be the last year and the remaining data can comprise some of all data older than one year. The ground truth labels can then be calculated for each user by computing an average order value, frequency of orders, and/or a total spend by a user during the holdout period. Further, step 302 can include identifying, for each user, whether the user made any purchases during the holdout period (e.g., whether the user returned or churned).

In step 304, method 300 can include splitting the dataset (D) into a training dataset (Dₜᵣₐᵢₙ) and a testing dataset (Dₜₑₛₜ). In the embodiments, the specific train/test split threshold can vary depending on the needs of the system. For example, an 80% to 20% train/test split can be used, although other splits may be used. As another example, a time-based split can be used (e.g., splitting the dataset based on an explicit time).

In step 306, method 300 can include balancing the training dataset to generate a balanced training dataset (Dₜᵣₐᵢₙ_{_{B}}). In some embodiments, various balancing techniques can be used to balance the training dataset including over-sampling (e.g., generating synthetic examples), under-sampling (e.g., removing feature vectors with features in predominant classes), per-class weighting of each feature, and decision thresholding. Regardless of the approach taken, the resulting balanced training dataset ensures that all classes of features equally (or close to equally) represented in the balanced training dataset.

In step 308, method 300 can include training a balanced predictive model using the balanced training dataset (Dₜᵣₐᵢₙ_{_{B}}) In some embodiments, the balanced predictive model includes a churn model. In an embodiment, the churn model can comprise a random forest model. The specific details of training the weights and hyperparameters of the balanced predictive model are not limiting and any reasonable training technique can be used. The resulting balanced predictive model trained using Dₜᵣₐᵢₙ_{_{B}} is referred to as Pᵣₑₜᵤᵣₙ_{_{B}}.

In step 310, method 300 can include calibrating the balanced predictive model using the training data (Dₜᵣₐᵢₙ). Various techniques can be used to calibrate the balanced predictive model. For example, Platt scaling can be used to calibrate Pᵣₑₜᵤᵣₙ_{_{B}} using the unbalanced training data (Dₜᵣₐᵢₙ) As another example, isotonic regression may also be used to calibrate Pᵣₑₜᵤᵣₙ_{_{B}}. The specific choice of calibration is not intended to be limiting. Indeed, step 306, step 308, and step 310 may reasonably be replaced with alternative methods so long as the chosen steps result in a classifier that can predict the likelihood a user returns or churns. The resulting calibrated model, also referred to as the first predictive model, is referred to as Pᵣₑₜᵤᵣₙ.

In step 312, method 300 can include training frequency and AOV models on the training data. Details on these models were provided in connection with FIGS. 1 and 2 and are not repeated herein. Briefly, the frequency and AOV models can comprise discriminative models, such as random forest models, that are trained on Dₜᵣₐᵢₙ to predict the frequency of orders and an AOV, respectively. As discussed, ground truths for Dₜᵣₐᵢₙ can be obtained by computing the order frequency and AOV during the holdout period. Although random forests are used as examples, other types of discriminative models can be used. Further, the specific training techniques for the frequency and AOV models are not limiting and any reasonable technique can be used. The resulting frequency and AOV models are referred to as AOVᵣₑₜᵤᵣₙ and Freqᵣₑₜᵤᵣₙ, respectively.

In step 314, method 300 can include generating an interim CLV model. In an embodiment, the interim CLV model can comprise a metamodel that combines the outputs of AOVᵣₑₜᵤᵣₙ and Freqᵣₑₜᵤᵣₙ. For example, the interim CLV model can represent the product of AOVᵣₑₜᵤᵣₙ and Freqᵣₑₜᵤᵣₙ. As such, the resulting interim CLV model may not require additional training and can be performed using the already trained AOVᵣₑₜᵤᵣₙ and Freqᵣₑₜᵤᵣₙ models.

In step 316, method 300 can include fitting a sigmoid for the first predictive model (Pᵣₑₜᵤᵣₙ) In an embodiment, step 316 can include identifying one or more trainable parameters that satisfy a predefined cost function. In an embodiment, the one or more trainable parameters can comprise the trainable parameters of a sigmoid function. In an embodiment, the number of trainable parameters is two, although other numbers may be used. As one example, the sigmoid function can be represented as

$${σ}_{{t}_{1} , {t}_{2}} ( x ) = \frac{1}{1 + {e}^{- {t}_{1} * ( x - {t}_{2} )}} \qquad Equation 11$$

In Equation 11, t₁ and t₂ comprise the trainable parameters fit in step 316. In an embodiment, step 316 can include computing the minimum values of the one or more trainable parameters to satisfy the predefined cost function. In one example, the cost function may be:

σₜ_{₁}_{,t}_{₂}(Pᵣₑₜᵤᵣₙ(x))CLVᵣₑₜᵤᵣₙ(x)−C̅L̅V̅(̅x̅)̅ Equation 12

In Equation 12, σₜ_{₁}_{,t}_{₂}(x) comprises the sigmoid function of Equation 11 (or a similar function) applied to Pᵣₑₜᵤᵣₙ(x), which comprises the probability that a given user x makes a purchase in the holdout period (computed using the model calibrated in step 310), CLVᵣₑₜᵤᵣₙ(x) comprises the predicted CLV for user x during the holdout period (computed using the model generated in step 312 and step 314) and C̅L̅V̅(̅x̅)̅ comprises the ground truth CLV for user x received or calculated in step 302.

In step 316, method 300 computes the minimum values using the trained set of users (Dₜᵣₐᵢₙ) and the cost function of Equation 12 applied to each. Specifically, step 316 can include solving the following Equation 13 to fit the parameters of the sigmoid:

$${σ}_{{t}_{1}^{⋆} , {t}_{2}^{⋆}} = arg {min}_{{t}_{1} , {t}_{2}} \vert {\sum }_{x ∈ {D}_{train}} {σ}_{{t}_{1} , {t}_{2}} ( {P}_{return} ( x ) ) C L {V}_{return} ( x ) - \overline{C L V ( x )} \vert \qquad Equation 13$$

Here, σₜ_{₁}_{*,t}_{₂}_{*}(x) represents the fitted sigmoid function (e.g., the fitted sigmoid of Equation 11). As illustrated, method 300 finds the minimum values of t₁ and t₂ by finding the values that minimize the summation of prediction errors computed over all users in the training set x∈Dₜᵣₐᵢₙ In some embodiments, after fitting the sigmoid, step 316 can include a further cross-validation step to further refine the predicted values of t₁ and t₂.

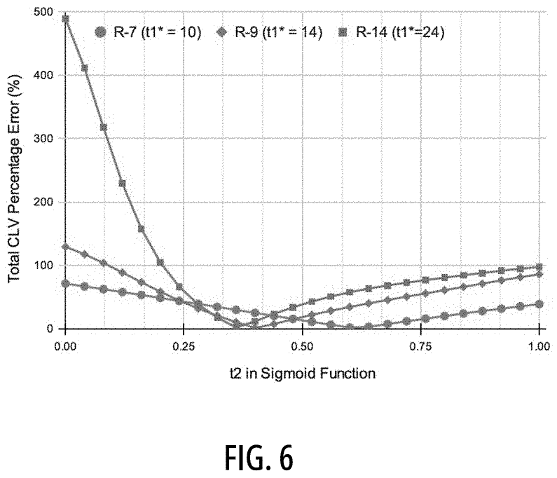

As illustrated, the fitted sigmoid focuses on minimizing the impact of CLV errors caused by churn misclassifications. The larger t₁ and |t₂−0.5| are (using 0.5 as an example default classifier threshold), the more distortion the sigmoid function provides. FIG. 6 gives examples of σₜ_{₁}_{*,t}_{₂}_{*} in three retail brands and illustrates how the CLV errors change with t₂. Among these brands, R-7 has the lowest AOV ($82.9) and the highest return rate (31.3%), R-14 has the highest AOV ($188.5) and the lowest return rate (8.3%). R-7 gets the most aggressive adjustment, with C2 as low as 0.28. The total CLV prediction error is used as the cost function because by predicting the total revenue correctly, the model captures the overall purchase pattern better and is less susceptible to overfitting (than individual-level metrics, such as MAE). The approach demonstrates a consistent MAE reduction. Besides CLV errors, other financial-based cost functions can also be used to improve different business objectives.

In step 318, method 300 can include generating a CLV model. Similar to step 314, in some embodiments, the final CLV model generated in step 318 can comprise a combination of previously trained models. In an embodiment, the final CLV can comprise the product of the fitted sigmoid, first predictive model, and interim CLV model:

CLV(x)=*σₜ_{₁}_{*,t}_{₂}_{*}(Pᵣₑₜᵤᵣₙ(x))CLVᵣₑₜᵤᵣₙ(x) Equation 14

In step 320, method 300 can include outputting the models. In some embodiments, step 320 can initially include using the test data Dₜₑₛₜ to validate Pᵣₑₜᵤᵣₙ and CLVᵣₑₜᵤᵣₙ using any reasonable testing strategy (e.g., cross-validation). In some embodiments, step 320 can include outputting the weights and other parameters of only the final CLV model. In other embodiments, step 320 can also include outputting the weights and other parameters of the fitted sigmoid, first predictive model, and/or interim CLV model independently. Specifically, the interim models used to build the final CLV model may also be used independently of the CLV model. The outputted models may then be used by one or more downstream processes that use CLV predictions.

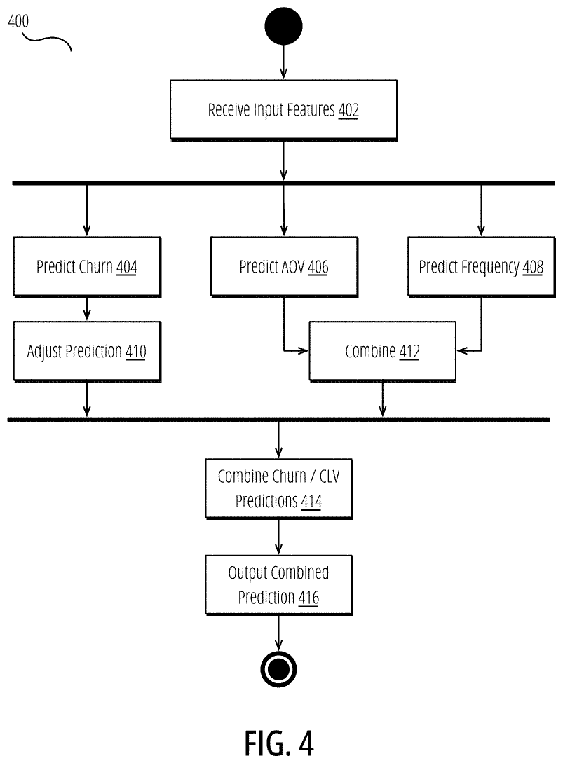

FIG. 4 is a flow diagram illustrating a method for predicting a CLV using a multi-stage model according to some of the example embodiments. Various details of the models discussed in FIG. 4 have been described with respect to FIGS. 1 through 3 above and are not repeated herein.

In step 402, method 400 can include receiving input features. In an embodiment, these input features can be associated with a single user and method 400 can be executed on a per-user basis (or batched). In some embodiments, the input features can be stored in a vector (such as that described in Table 7) and step 402 can include receiving a vector that includes a plurality of features related to a user.

In step 404, method 400 can include predicting a churn or return probability for the user associated with the features using a first predictive model. In some embodiments, the first predictive model corresponds to churn model 202 and the disclosure of churn model 202 is not repeated. In brief, the first predictive model may be a classification model configured to generate a probability that a user does not interact with an entity within a forecast window. For example, the first predictive model can comprise a random forest model trained using historical data (as described in steps 302 through 308). The output of the first predictive model thus comprises a probabilistic value that a user will return or churn.

In step 406, method 400 can include predicting the AOV of the user and in step 408, method 400 can include predicting the order frequency of a user. In both steps, independent predictions are made. In an embodiment, step 406 can include using the AOV model 206 while step 408 can include using the frequency model 204 as described previously and not repeated herein. In brief, in step 406, method 400 inputs the user features and receives an average order value for the user over the forecast window while, in step 408, method 400 inputs the user features and receives an order frequency.

In step 410, method 400 can include adjusting the return probability calculated in step 404 using a fitted sigmoid function to generate an adjusted return probability. In an embodiment, adjusting the return probability using a fitted sigmoid function comprises inputting the return probability into the fitted sigmoid function. In some embodiments, the fitted sigmoid function includes at least one trainable parameter. Details of the fitted sigmoid function, and training thereof, are provided in the description of step 316 and not repeated herein. In general, the fitted sigmoid will “squash” the raw output of the first predictive model.

In step 412, method 400 includes combining the output of the AOV model and the frequency model. In some embodiments, step 412 can include multiplying the predictive outputs of these models together to obtain an interim CLV value.

In step 414, method 400 can include predicting a lifetime value of the user using the adjusted return probability (step 410) and the interim CLV value (step 412). In some embodiments, step 414 can include multiplying the adjusted return probability by the interim CLV value to adjust the interim CLV value based on the adjusted likelihood of churning or returning. In some embodiments, the lifetime value of the user comprises a residual lifetime value of the user, the residual lifetime value of the user comprising the value of the user over a future forecast period (e.g., the next year).

Finally, in step 416, method 400 can include outputting the combined prediction. In some embodiments, the CLV prediction can be provided to downstream applications for various use cases which are non-limiting.

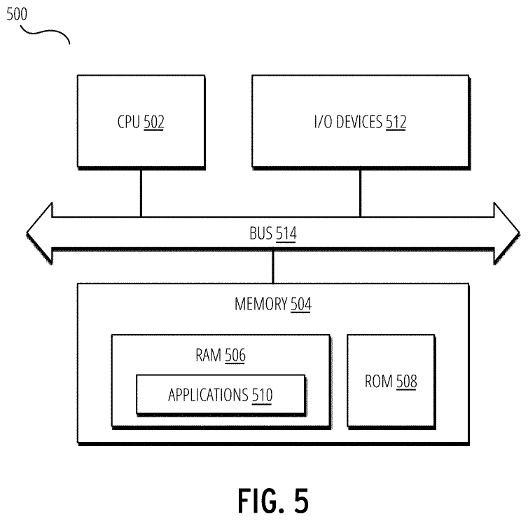

FIG. 5 is a block diagram of a computing device according to some embodiments of the disclosure. In some embodiments, the computing device can be used to train and/or use the various ML models described previously.

As illustrated, the device includes a processor or central processing unit (CPU) such as CPU 502 in communication with a memory 504 via a bus 514. The device also includes one or more input/output (I/O) or peripheral devices 512. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 502 may comprise a general-purpose CPU. The CPU 502 may comprise a single-core or multiple-core CPU. The CPU 502 may comprise a system-on-a-chip (SoC) or a similar embedded system. In some embodiments, a graphics processing unit (GPU) may be used in place of, or in combination with, a CPU 502. Memory 504 may comprise a memory system including a dynamic random-access memory (DRAM), static random-access memory (SRAM), Flash (e.g., NAND Flash), or combinations thereof. In an embodiment, the bus 514 may comprise a Peripheral Component Interconnect Express (PCIe) bus. In some embodiments, bus 514 may comprise multiple busses instead of a single bus.

Memory 504 illustrates an example of computer storage media for the storage of information such as computer-readable instructions, data structures, program modules, or other data. Memory 504 can store a basic input/output system (BIOS) in read-only memory (ROM), such as ROM 508, for controlling the low-level operation of the device. The memory can also store an operating system in random-access memory (RAM) for controlling the operation of the device

Applications 510 may include computer-executable instructions which, when executed by the device, perform any of the methods (or portions of the methods) described previously in the description of the preceding Figures. In some embodiments, the software or programs implementing the method embodiments can be read from a hard disk drive (not illustrated) and temporarily stored in RAM 506 by CPU 502. CPU 502 may then read the software or data from RAM 506, process them, and store them in RAM 506 again.

The device may optionally communicate with a base station (not shown) or directly with another computing device. One or more network interfaces in peripheral devices 512 are sometimes referred to as a transceiver, transceiving device, or network interface card (NIC).

An audio interface in peripheral devices 512 produces and receives audio signals such as the sound of a human voice. For example, an audio interface may be coupled to a speaker and microphone (not shown) to enable telecommunication with others or generate an audio acknowledgment for some action. Displays in peripheral devices 512 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 512 may comprise any input device arranged to receive input from a user. An illuminator in peripheral devices 512 may provide a status indication or provide light. The device can also comprise an input/output interface in peripheral devices 512 for communication with external devices, using communication technologies, such as USB, infrared, Bluetooth®, or the like. A haptic interface in peripheral devices 512 provides tactile feedback to a user of the client device.

A GPS receiver in peripheral devices 512 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In an embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 5, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein. Example embodiments are provided merely to be illustrative. Likewise, the reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, can be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order. For example, two blocks shown in succession can, in fact, be executed substantially concurrently, or the blocks can sometimes be executed in the reverse order, depending upon the functionality/acts involved.

For the purposes of this disclosure, a non-transitory computer-readable medium (or computer-readable storage medium/media) stores computer data, which data can include computer program code (or computer-executable instructions) that is executable by a computer, in machine-readable form. By way of example, and not limitation, a computer-readable medium may comprise computer-readable storage media for tangible or fixed storage of data or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid-state memory technology, CD-ROM, DVD, or other optical storage, cloud storage, magnetic cassettes, magnetic tape, magnetic disk storage, or other magnetic storage devices, or any other physical or material medium which can be used to tangibly store the desired information or data or instructions and which can be accessed by a computer or processor.

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

1. A method comprising:
receiving a vector, the vector comprising a plurality of features related to a user;
predicting a return probability for the user based on the vector using a first predictive model;
adjusting the return probability using a fitted sigmoid function to generate an adjusted return probability; and
predicting a lifetime value of the user using the adjusted return probability and at least one other prediction by combining the adjusted return probability and the at least one other prediction.

2. The method of claim 1, wherein the first predictive model comprises a classification model configured to generate a probability that user does not interact with an entity within a forecast window.

3. The method of claim 1, wherein adjusting the return probability using a fitted sigmoid function comprises inputting the return probability into the fitted sigmoid function.

4. The method of claim 1, wherein the fitted sigmoid function comprises at least one trainable parameter.

5. The method of claim 1, wherein predicting a lifetime value of the user using the adjusted return probability and at least one other prediction comprises computing a product of the adjusted return probability and at least one other prediction.

6. The method of claim 1, wherein predicting a lifetime value of the user using the adjusted return probability and at least one other prediction comprises predicting an average order value of the user using the vector and an order frequency of the user using the vector and combining the average order value, order frequency, and adjusted return probability.

7. A method comprising:
training a first predictive model using a training dataset, the first predictive model configured to output a probabilistic value;
training a plurality of discriminative models using the training dataset, each of the plurality of discriminative models configured to output a continuous value;
generating a fitted sigmoid function by fitting at least one parameter of a sigmoid function, the at least one parameter identified by finding a corresponding minimum value that satisfies a predefined cost function; and
generating a customer lifetime value (CLV) model using the fitted sigmoid function, the first predictive model, and the plurality of discriminative models.

8. The method of claim 7, wherein the plurality of discriminative models include a plurality of random forest models.

9. The method of claim 8, wherein the plurality of random forest models include an order frequency random forest model and an average order value (AOV) random forest model.

10. The method of claim 7, wherein the first predictive model comprises a random forest model predicting a churn probability of a user.

11. The method of claim 7, wherein generating the fitted sigmoid function comprises computing an error metric between predicted CLVs and a ground truth CLVs for a plurality of users in the training dataset and identifying a value of the at least one parameter that minimizes the summation.

12. The method of claim 11, wherein computing an error metric between predicted CLVs and a ground truth CLVs comprises computing an arg min of the summation.

13. The method of claim 7, wherein generating the CLV model using the fitted sigmoid function, the first predictive model, and the plurality of discriminative models comprises multiplying predictions of the first predictive model and the plurality of discriminative models by the output of the sigmoid function.

14. A non-transitory computer-readable storage medium for tangibly storing computer program instructions capable of being executed by a computer processor, the computer program instructions defining steps of:
training a first predictive model using a training dataset, the first predictive model configured to output a probabilistic value;
training a plurality of discriminative models using the training dataset, each of the plurality of discriminative models configured to output a continuous value;
generating a fitted sigmoid function by fitting at least one parameter of a sigmoid function, the at least one parameter identified by finding a corresponding minimum value that satisfies a predefined cost function; and
generating a customer lifetime value (CLV) model using the fitted sigmoid function, the first predictive model, and the plurality of discriminative models.

15. The non-transitory computer-readable storage medium of claim 14, wherein the plurality of discriminative models include a plurality of random forest models.

16. The non-transitory computer-readable storage medium of claim 15, wherein the plurality of random forest models include a order frequency random forest model and an average order value (AOV) random forest model.

17. The non-transitory computer-readable storage medium of claim 14, wherein the first predictive model comprises a random forest model predicting a churn probability of a user.

18. The non-transitory computer-readable storage medium of claim 14, wherein generating the fitted sigmoid function comprises computing an error metric between predicted CLVs and a ground truth CLVs for a plurality of users in the training dataset and identifying a value of the at least one parameter that minimizes the summation.

19. The non-transitory computer-readable storage medium of claim 18, wherein computing an error metric between predicted CLVs and a ground truth CLVs comprises computing an arg min of the summation.

20. The non-transitory computer-readable storage medium of claim 14, wherein generating the CLV model using the fitted sigmoid function, the first predictive model, and the plurality of discriminative models comprises multiplying predictions of the first predictive model and the plurality of discriminative models by the output of the sigmoid function.
